(19) United States
(12) Patent Application Publication
(10) Pub. No.: US 2011/0299601 A1
(43) Pub. Date: Dec. 8, 2011

(54) SCALABLE VIDEO MULTICAST FRAMEWORK FOR HETEROGENEOUS ENDPOINTS

(75) Inventors: Cheng-Jia Lai, Mountain View, CA (US); Chao-Li Tarng, Palo Alto, CA (US); Jing Li, Palo Alto, CA (US)

(73) Assignee: CISCO TECHNOLOGY, INC., San Jose, CA (US)

(21) Appl. No.: 12/795,773

(22) Filed: Jun. 8, 2010

(51) Int. Cl. H04N 7/12

(52) U.S. Cl. 375/240.25; 375/E07.026

(57) ABSTRACT

Techniques are provided for a scalable video multicast framework. In one form, a network device receives information indicating video decoding parameters of an endpoint network device. One or more video streams are received are the network device. A video stream is generated from the one or more video streams for the endpoint network device based on the video decoding. The video stream is transmitted to the endpoint network device. In another form, video decoding parameters from a plurality of endpoint network devices are received at a network device. An incoming video stream is received at the network device that is intended for the plurality of endpoint network devices. One or more outgoing video streams are generated from the incoming video stream for the plurality of endpoint network devices based on a highest video quality indicated by the video decoding parameters.

### TECHNICAL FIELD

The present disclosure relates generally to video teleconferencing, and more specifically to scaling multicast video streams according to an endpoint's coder/decoder (codec) capabilities.

### BACKGROUND

In a typical video communications environment, it is not unusual to have endpoints with heterogeneous or diverse video resolutions and codec capabilities, such as International Telecommunications Union (ITU) Recommendations H.263 and H.264 Advanced Video Coding (AVC), with various profiles. In other words, each endpoint may have a different codec and each endpoint is considered to be heterogeneous with respect to their respective codecs and/or decoder equipment. In a video session, when heterogeneous endpoints are engaged, the video content quality will suffer for some endpoints because the video usually has to be encoded to accommodate the lowest resolution and quality, i.e., a minimum content quality, from among the endpoints in the video session. Thus, endpoints with more advanced codecs or better equipment will still have to decode video that does not fully utilize the endpoint's decoding capability. The minimal content quality can result in poor user experiences (Quality of Experience (QoE)) for those in the video session that use higher-quality decoding at the endpoints.

Scalable video coding (SVC) technologies such as those defined in H.264 Annex G and the Motion Pictures Experts Group (MPEG) MPEG-2 standards have been proposed to partially address endpoint heterogeneity. The true advantages of these scalable codecs are alternatively considered to be fault-resilience and traffic engineering regarding packet losses and priority queuing in the wide area network and wireless network environments. SVC implementations have high complexity and have not yet become widely supported by video endpoints in many environments. Thus, many video communications environments have yet to benefit from SVC multilayer traffic engineering and fault resilience for network Quality of Service (QoS) in order to maximize the content quality delivered to each individual endpoint for QoE.

### BRIEF DESCRIPTION OF THE DRAWINGS

FIG. 1 is a block diagram showing an example of a system in which a video stream is distributed to a plurality of network endpoints that are configured with various video codecs.

FIG. 2 is a block diagram showing an example of a video conferencing system with a conference bridge that distributes video to a plurality of network endpoints that are configured with various video codecs.

FIG. 3 is an example block diagram of a network device that is configured to generate from a received multicast video stream a scaled or transcoded video stream for a particular endpoint codec.

FIG. 4 is an example block diagram of a network device that is configured to generate one or more multicast video streams that may be scaled for a particular endpoint codec.

FIG. 5 is an example of a flowchart generally depicting a process for generating a scaled video stream from one or more multicast video streams.

FIG. 6 is an example of a flowchart generally depicting the process for generating one or more multicast video streams that may be scaled for a particular endpoint codec.

FIG. 7 is an example of a video distribution network with a node that is configured to generate a multicast Scalable Video Coding (SVC) video stream with multiple layers that are each encapsulated into separate Real-time Transport Protocol (RTP) streams.

FIG. 8 is an example of a video distribution network with a node that is configured to generate an SVC video stream with multiple layers that are encapsulated into a single RTP stream.

FIG. 9 is an example of a video distribution network with a node that is configured to generate an SVC video stream with multiple layers that are selectively encapsulated into multiple RTP streams.

### DESCRIPTION OF EXAMPLE EMBODIMENTS

Overview

Techniques are provided for a scalable video multicast framework. In one form, a network device receives information indicating video decoding parameters of an endpoint network device. One or more video streams are received at the network device. A video stream is generated from the one or more video streams for the endpoint network device based on the video decoding parameters. The video stream is transmitted to the endpoint network device.

In another form, video decoding parameters from a plurality of endpoint network devices are received at a network device. An incoming video stream is received at the network device that is intended for the plurality of endpoint network devices. One or more outgoing video streams are generated from the incoming video stream for the plurality of endpoint network devices based on a highest video quality indicated by the video decoding parameters of each of the plurality of network endpoint devices. The one or more outgoing video streams are transmitted to the plurality of endpoint network devices.

### Example Embodiments

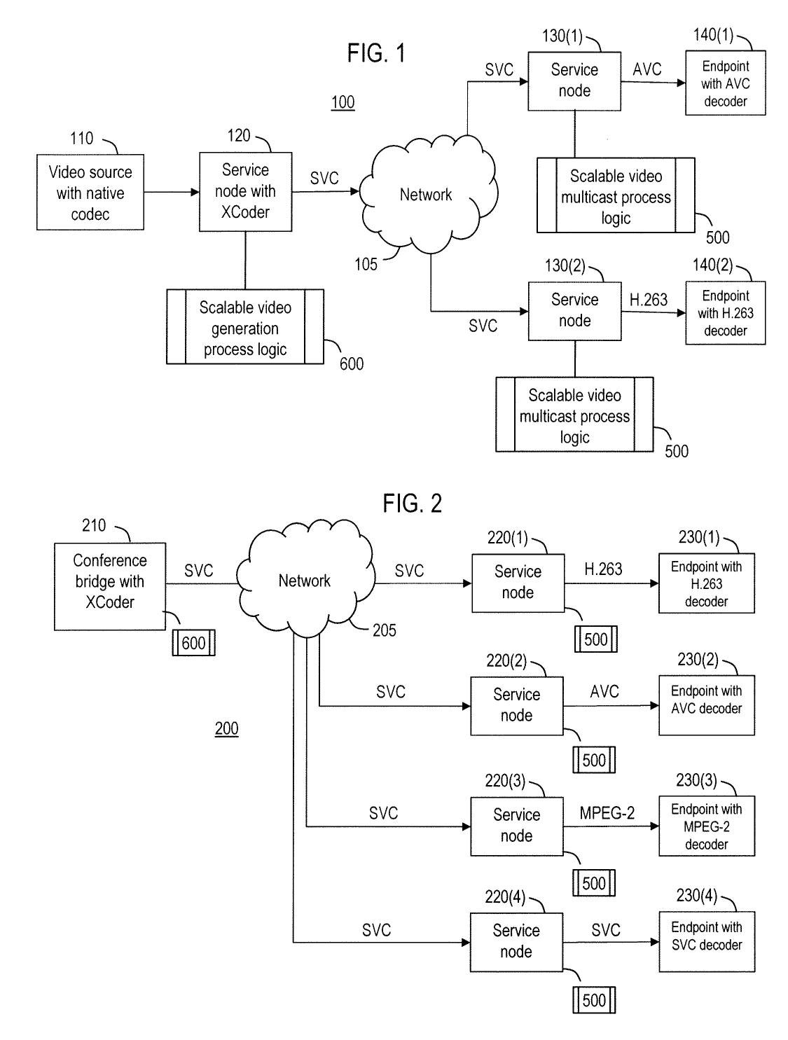

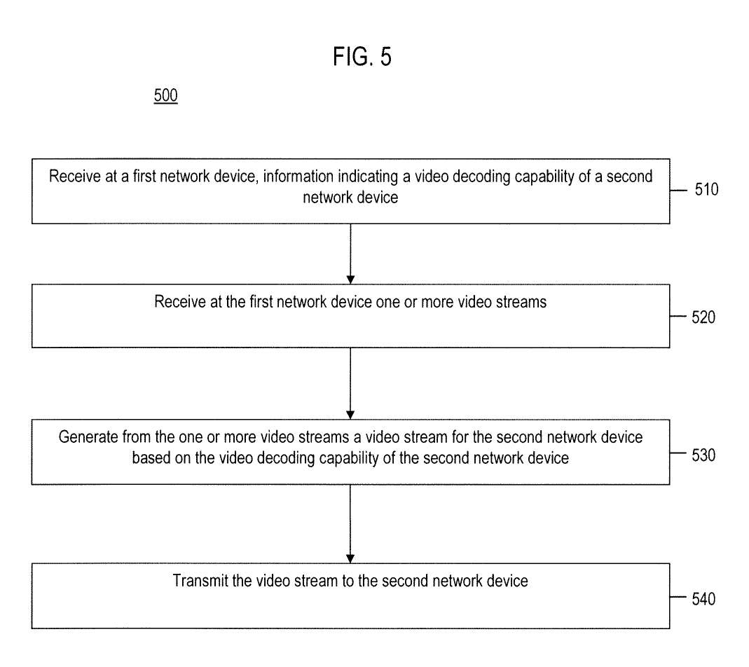

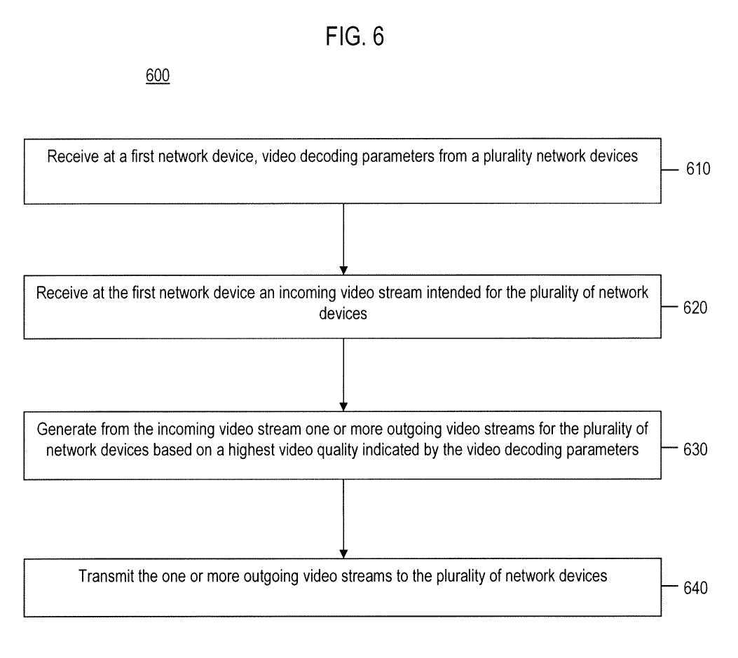

Referring first to FIG. 1, a block diagram is shown that depicts an example system 100 that distributes a scalable video stream to various endpoints with heterogeneous codecs. The system 100 comprises a network 105, a video source 110, a service node 120 with a transcoder, a plurality of endpoint service nodes, two of which are shown at reference numerals 130(1) and 130(2), and a plurality of network endpoints, two of which are shown at reference numerals 140(1) and 140(2). Each service node 130(1) and 130(2) is configured with scalable video multicast process logic 500 and service node 120 is configured with scalable video generation process logic 600. Briefly, the scalable video multicast process logic 500 is configured to scale a video stream for a particular endpoint codec from a scalable video stream that is generated by scalable video generation process logic 600. The scalable video multicast process logic 500 will generally be described in connection with FIGS. 1, 2, and 3, and described in greater detail in connection with FIGS. 5 and 7-9. The scalable video generation process logic 600 will generally be described in connection with FIGS. 1, 2, and 4, and described in greater detail in connection with FIGS. 6-9.

The video source 110 can be any video source for video that is to be distributed over a network to various endpoints, e.g., switched digital video, video on demand, Internet video, etc. The video source may encode the video with its native or embedded codec, e.g., an H.264 AVC, an H-263, or MPEG-2 video codec. The video source 110 transmits video to the service node 120. The service node 120 transcodes the video to an SVC video stream by executing the scalable video generation process logic 600. The SVC stream comprises at least a base layer and one or more optional enhancement layers. The SVC standard is built upon the AVC standard and the base layer conforms to the AVC standard. The SVC stream is multicast to endpoints that have joined the multicast group, e.g., endpoints 140(1) and 140(2).

Before reaching the endpoints 140(1) and 140(2) the SVC video stream will pass through endpoint service nodes 130(1) and 130(2). The endpoint service nodes 130(1) and 130(2) adapt the SVC video stream to each endpoint's decoding requirements. For example, service node 130(1) knows that its associated endpoint, endpoint 140(1), has an AVC decoder, and will forward the SVC base layer when executing the scalable video multicast process logic 500. Similarly, service node 130(2) knows that endpoint 140(2) has an H.263 decoder and will transcode the SVC stream to an H.263 compliant stream before sending it to endpoint 140(2). Depending on system requirements, each of the endpoint service nodes may or may not be configured with a transcoder.

In one example, the service nodes 120, 130(1), and 130(2) receive information about how the video is to be encoded for each endpoint. The information may include parameters such as codec type, desired bit rate, frame rate, video resolution, etc. The bit rates may be lowered by the encoders via quantization parameters that also lower the signal-to-noise ratio (SNR), i.e., a lower bit rate results in a lower SNR, and therefore, a lower video quality. Once the service node 120 receives this information from all of the endpoints that will receive the multicast SVC stream, then the service node 120 can encode the SVC stream to the highest video quality that will be used by the multicast group. In some instances, the video source 110 may provide an SVC compliant stream and the service node 120 will not have to perform transcoding.

As can be seen from the examples described in connection with FIG. 1, a scalable video multicast (SVM) video-service framework is provided that seamlessly adapts video to heterogeneous video endpoints that may have diverse codec capabilities, such as different video resolutions and codec qualities, but that do not support SVC and/or do not have the ability to receive multicast streams. The techniques described herein enable transparent use of traffic engineering in multiple scalable layers for fault resilience and transmission efficiency. In the SVM framework, a service node, e.g., service node 120, multicasts a unidirectional video stream in scalable-coded multiple layers with QoS markings for traffic engineering, while endpoint service nodes, e.g., service nodes 130(1) and 130(2), are deployed near the endpoints, and perforin any necessary bit-stream rewriting and/or quality enhancement on behalf of the network endpoints, but do so in a manner that is transparent to the network endpoints, i.e., from each individual network endpoint's view, the best combination of these scalable layers can be received by the associated service node and reconstructed into an output stream so that the respective endpoint may receive the optimal video quality with respect to its own decoding capabilities.

Referring to FIG. 2, a block diagram is shown that depicts an example system 200 with various nodes or network devices that are engaged in a teleconferencing session. The system 200 comprises a network 205, a conference bridge 210, a plurality of endpoint service nodes 220(1)-220(4), and a plurality of conference endpoints 230(1)-230(4). Each of the service nodes 220(1)-220(4) is configured with scalable video multicast process logic 500 and conference bridge 210 is configured with scalable video generation process logic 600.

As shown in FIG. 2, a multicast SVC stream is streamed from the conference bridge 210. The multicast SVC stream is distributed across system 200 according to a network multicasting protocol, e.g., Internet Group Management Protocol (IGMP) and Protocol Independent Multicast—Sparse Mode (PIM-SM). The multicast distribution from the conference bridge 210 assumes that a multicast tree has been built and all of the endpoints have joined the multicast group, e.g., according to IGMP and PIM-SM. In this example, the multicast SVC stream is sent to each of the endpoint service nodes 220(1)-220(4). The multicast SVC stream may be encapsulated using RTP to ensure timely delivery to the endpoints 230(1)-230(4).

Each of the conference endpoints 230(1)-230(4) has a different codec, e.g., the conference endpoints 230(1)-230(4) have H.263, AVC, MPEG-2, and SVC codecs, respectively. The conference bridge 210 will account for the various codecs and other requirements when encoding the outgoing multicast SVC stream. The corresponding service nodes 220(1)-220(4) will then transcode the SVC stream or forward the appropriate SVC layers to a corresponding conference endpoint.

The SVM framework can support any video endpoint whether or not an endpoint can decode a multilayer video stream that has been encoded according to a scalable coding scheme. When joining a session, an endpoint publishes its desired video quality and codec, and the SVM framework uses this description to automatically allocate and associate a service node to the endpoint. The associated service node intercepts video streams going to and from the endpoint, depending on whether the endpoint joined the session to receive and/or send video, and performs any necessary transcoding, content conversion, bit-stream rewriting (multilayer to/from single-layer), up-scaling with enhancement, and/or quality down-scaling. If an endpoint both sends and receives video in the same session, SVM may allocate either one or two service nodes to handle the video streams in both directions. If only one service node is allocated, the service node may need to handle codec asymmetry that may exist in each direction. If two service nodes are allocated, they can operate separately for each direction.

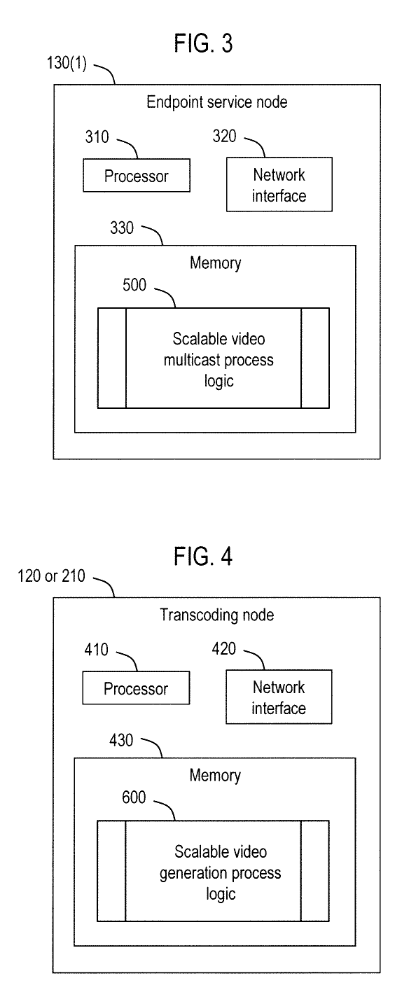

Referring now to FIG. 3, an example block diagram of a network device, e.g., endpoint service node 130(1), that is configured to perform or execute the scalable video multicast process logic 500, is described. The endpoint service node 130(1) comprises a processor 310, a network interface unit 320, and a memory 330. The network interface unit 320 enables communication between the endpoint service node 130(1) and other network elements in the system 100, such as by way of wired, wireless, or optical interfaces. The memory 330 stores instructions for the scalable video multicast process logic 500. The scalable video multicast process logic 500 scales a video stream for a particular endpoint according to the endpoint's video decoding parameters, e.g., for endpoint 140(1).

The processor 310 is a data processing device, e.g., a microprocessor, microcontroller, systems on a chip (SOCs), or other fixed or programmable logic. The processor 310 interfaces with the memory 330 that may be any form of random access memory (RAM) or other data storage memory block that stores data used for the techniques described herein. The memory 330 may be separate or part of the processor 310. Instructions for performing the scalable video multicast process logic 500 may be stored in the memory 330 for execution by the processor 310.

The functions of the processor 310 may be implemented by a processor or computer readable tangible medium encoded with instructions or by logic encoded in one or more tangible media (e.g., embedded logic such as an application specific integrated circuit (ASIC), digital signal processor (DSP) instructions, software that is executed by a processor, etc.), wherein the memory 330 stores data used for the computations or functions described herein (and/or to store software or processor instructions that are executed to carry out the computations or functions described herein). Thus, the process 500 may be implemented with fixed logic or programmable logic (e.g., software/computer instructions executed by a processor or field programmable gate array (FPGA)), or the processor or computer readable tangible medium may be encoded with instructions that, when executed by a processor, cause the processor to execute the process 500.

Referring to FIG. 4, an example block diagram of relevant portions of a transcoding network device that streams a multicast SVC stream to endpoint devices, e.g., the transcoding service node 120 or the conference bridge 210, is now described. This device comprises a processor 410, a network interface unit 420, and a memory 430. The processor 410, the network interface unit 420, and memory 430 may be configured to operate as described in connection with FIG. 3 for endpoint service node 130(1). The device shown in FIG. 4 is configured to generate multicast SVC streams using scalable video generation process logic 600. The memory 430 stores instructions for the scalable video stream generation process logic 600. The scalable video stream generation process logic 600 generates the multicast SVC streams based on a highest quality video decoding capability from among the plurality of network endpoints.

Turning now to FIG. 5, a flowchart depicting the scalable video multicast process logic 500 will now be described. At 510, at a network device, e.g., endpoint service node 130(1), information is received that indicates video decoding parameters of an endpoint network device. The information may include parameters such as codec type, desired bit rate, frame rate, video resolution, as mentioned above. These parameters may be forwarded upstream to other network devices, e.g. to a conference bridge.

At 520, one or more video streams are received by the network device. The one or more video streams may be multicast video streams that were encoded according to a scalable video encoding scheme that comprises at least a base layer and one or more optional enhancement layers. At 530, a video stream is generated for the endpoint network device from the one or more video streams video based on the decoding capability of an endpoint network device. At 540, the video stream is transmitted to the endpoint network device. In one example, one or more optional enhancement layers may be removed from the one or more multicast video streams and any remaining layers are forwarded to the endpoint network device.

Referring to FIG. 6, a flowchart is shown that depicts the process for generating one or more multicast video streams that may be scaled for a particular endpoint codec using scalable video stream generation process logic 600. At 610, video decoding parameters from a plurality of endpoint network devices are received at a network device. In one example, the video decoding parameters are received from a plurality of network endpoints at a conference bridge, as described above. At 620, an incoming video stream is received that is intended for the plurality of endpoint network devices. The video stream may be from a teleconference or other streaming video that is designated for the network endpoints.

At 630, one or more outgoing video streams are generated for the plurality of endpoint network devices based on a highest video quality indicated by the video decoding parameters. In one example, the one or more outgoing video streams are encoded according to a scalable video encoding scheme, e.g., the SVC standard, with a base layer and one or more optional enhancement layers. In one example, the one or more outgoing video stream are generated as a plurality of multicast streams. Each endpoint network device may be joined to the appropriate multicast group in order to receive video generated according the respective decoding parameters. At 640, the one or more outgoing video streams are transmitted to the plurality of endpoint network devices.

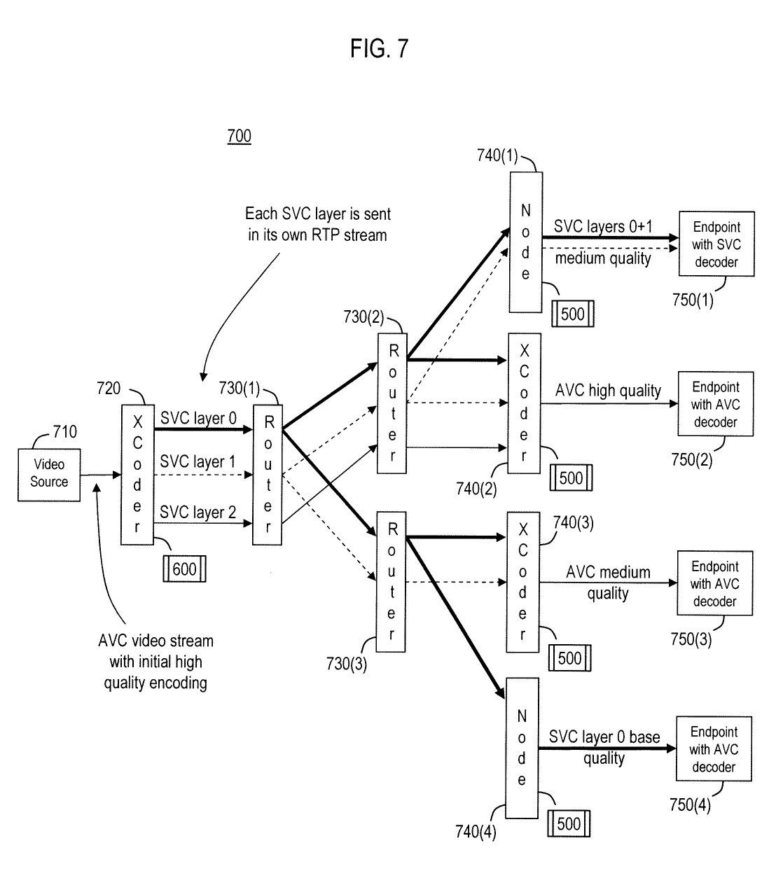

FIGS. 7-9 are several examples that illustrate the scalability and flexibility afforded by the techniques described herein. Like reference numerals in FIGS. 7-9 represent like components. Referring to FIG. 7, an example of a video distribution network 700 is shown with a node that is configured to implement the scalable video generation process logic 600 and a plurality of nodes that are configured to implement the scalable video multicast process logic 500. Network 700 has a video source 710, a transcoder (XCoder) node 720, a plurality of routers 730(1)-730(3), a plurality of endpoint service nodes 740(1)-740(4) with or without XCoders, and a plurality of endpoints with various video codecs 750(1)-750(4).

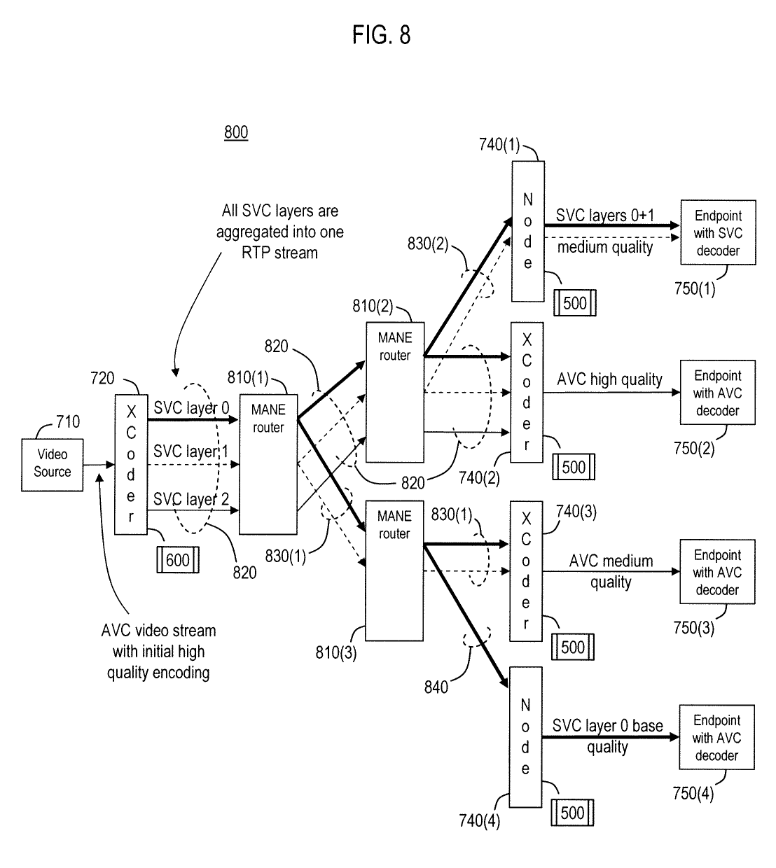

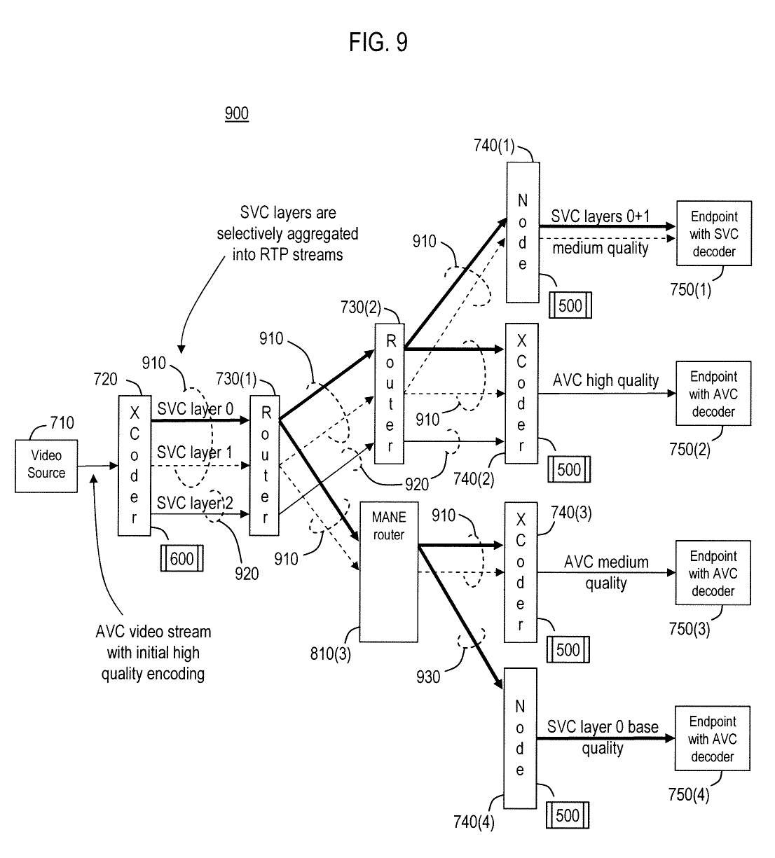

The video source 710 sends an AVC video stream that is initially encoded with a high quality. At the transcoder node 720, the high quality AVC stream is transcoded by the scalable video generation process logic 600 into an SVC video stream comprising three layers. The AVC base layer is passed through the transcoder node 720 and is denoted as “SVC layer 0”; while two enhancement layers are denoted as SVC layer 1 and SVC layer 2. Each of the SVC layers is individually encapsulated into a separate RTP stream as shown. The stream for SVC layer 0 is depicted as a thicker line, the stream for SVC layer 1 is depicted as a dashed line, and the stream for SVC layer 2 is depicted as a thinner line. Any transcoded stream transmitted to an endpoint is depicted as a thinner line, e.g., the AVC high quality stream that is transmitted from endpoint service node with XCoder 740(2) to endpoint with AVC decoder 750(2) and the AVC medium quality stream that is transmitted from service node with XCoder 740(3) to endpoint with AVC decoder 750(3). Streams in FIGS. 8 and 9 are depicted using the same scheme. Each RTP stream encapsulating the respective SVC layers are multicast to the endpoints 750(1)-750(4) according to their respective decoding parameters, as explained hereinafter.

Thus, the packets in each scalable layer are sent only to those service nodes that require the respective scalable layer. This is possible because the transcoder node 720 has received each endpoint's video requirements (decoding parameters) that were published in advance by endpoint service nodes 740(1)-740(4) on behalf of endpoints 750(1)-750(4), respectively. Each multicast distribution tree is built on the granularity of scalable layers and based on the published requirements from the endpoints 750(1)-750(4). For example, the stream for SVC layer 0 is needed by all endpoints 750(1)-750(4), and as such, each of the endpoints 750(1)-750(4) are joined to the multicast group for SVC layer 0. The stream for SVC layer 1 is needed by endpoints 750(1)-750(3) and the endpoints 750(1)-750(3) are joined to the multicast group for SVC layer 1. The stream for SVC layer 2 is only needed by endpoint 750(2) and endpoint 750(2) is joined to the multicast group for SVC layer 2. Each of the endpoint service nodes 740(1)-740(4) can convert the multicast streams to unicast streams when transmitting the SVC layers or transcoded video to each of the endpoints 750(1)-750(4).

The SVM framework can be easily implemented by any receiver-based multicast method that uses techniques to prevent loops from forming during the forwarding process, e.g., Reverse Path Forwarding (RPF) that used according to the Protocol Independent Multicast (PIM) and IGMP standards.

In addition, traffic engineering with multiple SVC layers can be applied by way of the multiple scalable layers for use in various applications. For example, each scalable layer may have its packets denoted with a QoS marking different from those in other scalable layers, for administrative purposes in traffic engineering and network bandwidth reservation as defined in existing methods, such as Differentiated Services Code Point (DSCP) and Resource Reservation Protocol (RSVP). SVM service nodes can perform QoS marking on SVC packets transparently to the endpoints so that the customized traffic engineering with SVC can be easily deployed for optimized QoE and network efficiency.

In this example, the RTP streams arrive at router 730(1) which routes SVC layers 0-2 to router 730(2) and routes SVC layers 0 and 1 to router 730(3). Router 730(2), in turn, routes SVC layers 0 and 1 to service node 740(1) and routes SVC layers 0-2 to service node with XCoder 740(2), while Router 730(3) routes SVC layers 0 and 1 to service node with XCoder 740(3) and routes SVC layer 0 to endpoint service node 740(4).

Service node 740(1) forwards SVC layers 0 and 1 to the endpoint 750(1) that employs an SVC decoder. SVC layers 0 and 1 provide SVC video at medium quality. Had endpoint 750(1) indicated in the decoding parameters that high quality video was desired, then SVC layer 2 could have been multicast to endpoint 750(1). Note that no transcoding is necessary at endpoint service node 740(1). At service node 740(2), SVC layers 0-2 are transcoded to provide high quality AVC video to endpoint 750(2), and at service node 740(3), SVC layers 0 and 1 are transcoded to provide medium quality AVC video to endpoint 750(3). Service node 740(4) passes SVC layer 0 to endpoint 750(4) to provide SVC base quality to the AVC decoder.

SVM service nodes are typically deployed in proximity to the network endpoints, e.g. with or as part of Internet edge routers on the enterprise campuses and branches. An SVM implementation may be included in an application with a centralized call control agent, such as the Cisco Unified Communication Manager (CUCM) or other call manager. With a call manager, the SVM service nodes can act as media resources similar to Media Termination Points (MTP) or hardware transcoders, such that they may be allocated by the call manager when the call manager sets up a switched video conference with heterogeneous endpoints. The call manager can use standard or proprietary signaling protocols, e.g., Session Initiation Protocol (SIP)/Session Description Protocol (SDP), H.323, or Skinny Client Control Protocol (SCCP), to negotiate the desired codec and quality of each endpoint.

With the deployment of SVM service nodes, the video stream originating from a conference bridge can be multicast in scalable-coded layers to traverse the network, and then reconstructed by SVM service nodes at the edge routers before reaching the endpoints. In the reverse direction, the video streams originating from the endpoints can optionally traverse the network via the SVM service nodes, but since they have only one receiver, e.g., a conference bridge, multicast streams may simply be replaced by a unicast stream that uses scalable-coding, e.g., for traffic engineering in the reverse path.

Referring to FIG. 8, an example of a video distribution network 800 is shown in which the routers 730(1)-730(3) have been replaced with Media Aware Network Element (MANE) routers 810(1)-810(3). A MANE router operates according to Request for Comments (RFC) 3984 which specifies the RTP payload format for H.264. The MANE router can parse RTP headers and payloads to perform certain actions based on the contents therein. In this example, MANE routers 810(1)-810(3) selectively remove information from a multicast stream.

In network 800, the endpoints 750(1)-750(4) receive essentially the same video and quality, and perform essentially the same functions as those described in connection with network 700 (FIG. 7). However, in this example, the scalable video generation process logic 600 executed by XCoder node 720 encapsulates all three SVC layers into a single RTP multicast stream 820 as indicated by the dashed ovals surrounding the SVC layers. When the RTP multicast stream 820 reaches MANE router 810(1) it forwards the RTP multicast stream 820 to MANE router 810(2) essentially untouched. Before transmitting the RTP multicast 820 stream to MANE router 810(3), the MANE router 810(1) removes SVC layer 2 information from the RTP multicast stream 820 to produce a modified RTP stream 830(1), as shown. The MANE router 810(2), in turn, forwards the entire RTP multicast stream 820 to service node with XCoder 740(2) and SVC layers 0 and 1 in a modified RTP multicast stream 830(2) to service node 740(1). MANE router 810(3) forwards the entire RTP multicast stream 830(1) that it receives (with SVC layers 0 and 1) to service node with XCoder 740(3) and SVC layer 0 in a modified RTP multicast stream 840 to service node 740(4).

Referring to FIG. 9, an example of a video distribution network 900 is shown that uses routers 730(1) and 730(2) from FIG. 7 and MANE router 810(3) from FIG. 8. In network 900, the endpoints 750(1)-750(4) receive essentially the same video and quality, and perform essentially the same functions as those described in connection with networks 700 and 800 from FIGS. 7 and 8, respectively. In this example, the scalable video generation process logic 600 executed by XCoder node 720 selectively encapsulates SVC layers 0 and 1 into a first RTP multicast stream 910 and encapsulates SVC layer 2 into a second RTP multicast stream 920 as indicated by the dashed ovals surrounding the SVC layers. XCoder node 720 transmits the first and second RTP multicast streams 910 and 920 to router 730(1). The router 730(1) forwards the first and second RTP multicast streams 910 and 920 to router 730(2), and forwards the first multicast stream 910 to MANE router 810(3).

The router 730(2) forwards the first and second RTP multicast streams 910 and 920 to service node with XCoder 740(2) and the first RTP multicast stream 910 to service node 740(1). In this example, service node with XCoder 740(2) combines the first and second RTP multicast streams 910 and 920 when transcoding video for network endpoint 750(2) during execution of the scalable video multicast process logic 500. MANE router 810(3) forwards the first RTP multicast stream 910 to service node with XCoder 740(3), removes SVC layer 1 information from the first RTP multicast stream 910, and transmits the modified RTP multicast stream 930 with SVC layer 0 to service node 740(4). The service node 740(4) forwards the SVC layer 0 to endpoint 750(4) thereby delivering base quality video.

The examples described in connection with FIGS. 7-9 demonstrate the flexibility and scaling attributes of both the scalable video multicast process logic 500 and the scalable video generation process logic 600 when different types of equipment are deployed in the video distribution network.

Techniques are provided for an SVM video-service framework. The SVM video-service framework seamlessly adapts video for heterogeneous video endpoints that may have diverse codec capabilities such as different video resolutions and codec attributes, but do not necessarily support scalable video coding and/or multicast streaming. SVM uses in-network media services to perform multicast streaming and to convert video formats to and from a scalable coding scheme, on behalf of the endpoints transparently, in order to maximize the QoE at the video endpoints and facilitate traffic engineering for network QoS.

The above description is intended by way of example only.

What is claimed is:

1. A method comprising:
receiving at a network device, information indicating video decoding parameters of an endpoint network device;
receiving at the network device one or more video streams; and
generating from the one or more video streams, a video stream for the endpoint network device based on the video decoding parameters.

2. The method of claim 1, further comprising transmitting the video stream to the endpoint network device.

3. The method of claim 1, wherein the video decoding parameters comprise one or more of video encoding type, bit rate, frame rate, and video resolution.

4. The method of claim 1, wherein receiving the one or more video streams comprises receiving one or more multicast video streams encoded according to a scalable video encoding scheme comprising at least a base layer and one or more optional enhancement layers.

5. The method of claim 4, wherein generating comprises including the base layer and one or more optional enhancement layers in the video stream.

6. The method of claim 4, wherein generating comprises removing one or more optional enhancement layers from the one or more multicast video streams and forwarding any remaining layers to the endpoint network device.

7. The method of claim 1, wherein generating comprises transcoding the one or more video streams to generate the video stream.

8. The method of claim 1, wherein receiving the video decoding parameters comprises receiving video decoding parameters for a plurality of endpoint network devices and generating the video stream comprises generating one or more outgoing video streams for the plurality of endpoint network devices based on a highest video quality indicated by the video decoding parameters.

9. A method comprising:
receiving at a network device video decoding parameters from a plurality of endpoint network devices;
receiving at the network device an incoming video stream intended for the plurality of endpoint network devices; and
generating from the incoming video stream one or more outgoing video streams for the plurality of endpoint network devices based on a highest video quality indicated by the video decoding parameters of each of the plurality of network endpoint devices.

10. The method of claim 9, further comprising transmitting the one or more outgoing video streams to the plurality of endpoint network devices.

11. The method of claim 9, wherein generating comprises encoding the one or more outgoing video streams according to a scalable video encoding scheme such that the outgoing video stream comprises a base layer and one or more optional enhancement layers.

12. The method of claim 11, wherein generating comprises generating the one or more outgoing video stream as a plurality of multicast streams, wherein each of the plurality of multicast streams encapsulates at least one of the base layer, the one or more optional enhancement layers, or a combination thereof.

13. An apparatus comprising:
a network interface unit configured to transmit and receive packets over a network; and
a processor configured to be coupled to the network interface unit and configured to:
receive information indicating video decoding parameters of an endpoint network device;
receive one or more video streams; and
generate from the one or more video streams a video stream for the endpoint network device based on the video decoding parameters.

14. The apparatus of claim 13, wherein the processor is configured to receive the one or more video streams comprising multicast video streams encoded according to a scalable video encoding scheme, wherein the one or more video streams comprise at least a base layer and one or more optional enhancement layers, and wherein the processor is configured to generate the video stream by transcoding the one or more video streams or removing one or more optional enhancement layers from the one or more multicast video streams, and to forward any remaining layers to the endpoint network device.

15. The apparatus of claim 13, wherein the processor is configured to generate the video stream based on the video decoding parameters that comprise one or more of video coding/decoding type, bit rate, frame rate, and video resolution.

16. The apparatus of claim 13, wherein the processor is configured to receive video decoding parameters from a plurality of endpoint network devices and generate the video stream based on a highest video quality indicated by the video decoding parameters.

17. A computer readable medium storing instructions that, when executed by a processor, cause the processor to:
receive information indicating video decoding parameters of an endpoint network device;
receive one or more video streams; and
generate from the one or more video streams, a video stream for the endpoint network device based on the video decoding parameters.

18. The computer readable medium of claim 17, wherein the instructions that cause the processor to receive the one or more video streams comprise instructions to receive multicast video streams encoded according to a scalable video encoding scheme that comprise at least a base layer and one or more optional enhancement layers and the instructions that generate comprise instructions that, when executed by the processor, cause the processor to generate the video stream by transcoding the one or more video streams, or removing one or more optional enhancement layers from the one or more multicast video streams, and further comprising instructions that, when executed by a processor, cause the processor to forward any remaining layers to the endpoint network device.

19. The computer readable medium of claim 17, wherein the instructions that generate comprise instructions to cause the processor generate the video stream based on the video decoding parameters that comprise one or more of video coding/decoding type, bit rate, frame rate, and video resolution.

20. The computer readable medium of claim 17, wherein the instructions that cause the processor to receive video decoding parameters comprise instructions that cause the processor to receive video decoding parameters from a plurality of endpoint network devices and the instructions that cause the processor to generate the video stream comprise instructions that cause the processor to generate the video stream based on a highest video quality indicated by the video decoding parameters.
